(19) United States
(12) Patent Application Publication
(10) Pub. No.: US 2011/0111946 A1
(43) Pub. Date: May 12, 2011

(54) STRUCTURE MADE OF CERAMIC MATERIAL AND RELATIVE PRODUCTION PROCESS

(76) Inventor: Yuri Schiocchet, Trichiana (IT)

(21) Appl. No.: 12/997,697

(22) PCT Filed: Jun. 18, 2009
(86) PCT No.: PCT/EP2009/057622

§ 371 Date: Jan. 28, 2011

(30) Foreign Application Priority Data
Jun. 19, 2008 (IT) TV2008A000085

(51) Int. Cl. C04B 35/19; C01B 33/26; C04B 35/622

(52) U.S. Cl. 501/130; 423/328.1; 501/128

(57) ABSTRACT

The present invention relates to a ceramic material structure (100) at least partly produced with a ceramic material comprising an effective quantity of Li—Al nesosilicates (euryptite) (110). In a further aspect thereof, the present invention relates to a process for producing the aforesaid ceramic material structure. The ceramic has a low thermal expansion and may be used for cooking plates, cooking utensils and similar applications requiring thermal shock resistance.

The present invention relates to a ceramic material structure, which is particularly suitable for being directly exposed to a heat source and therefore is particularly suitable for producing cooking utensils, cooking hobs and/or cooking plates, heating bodies and heat exchangers for heating systems, and the like.

In a further aspect thereof, the present invention relates to a process for the industrial production of said ceramic material structure.

The use of ceramic materials to produce cooking utensils, such as saucepans, oven-proof dishes, baking pans, plates and the like, is widely known.

The use of ceramic materials is also known to manufacture heating bodies and heat exchangers used in heating systems.

Ceramic materials give considerable advantages, above all in terms of uniform transmission of heat, resistance to corrosion, resistance to high temperatures, flexibility of use and improved aesthetic appearance.

Unfortunately, the ceramic materials that are nowadays commonly used have some drawbacks.

First, these materials have considerable thermal expansion coefficients, typically equal to or greater than 20 μm for a temperature variation of 280° C., and heterogeneous regions of lattice characterized by different thermal expansion coefficients.

These high and unevenly distributed thermal expansion coefficients often determine the onset of defects in the crystalline lattice of the ceramic material structure, above all in the case in which the latter is subjected to repeated and/or very rapid heating/cooling cycles, as often occurs in practice.

The aforesaid lattice defects can cause the onset of microcracks or even degenerate rapidly in to cracks and/or fractures in the ceramic material structure.

To overcome drawbacks of similar nature, further worsened by high thermal gradients at local level, glass-ceramic materials, which are characterized by relatively low thermal expansion coefficients, might be used.

Unfortunately, these materials are characterized for their relatively high costs and are difficult to machine at industrial level. To ensure good performances in terms of resistance to heat, with these materials, in practice it is only possible to produce substantially flat structures with a constant thickness, up to a few millimetres.

The main aim of the present invention is to provide a ceramic material structure, which allows the aforesaid drawbacks to be overcome.

Within this aim, one of the objects of the present invention is to provide a ceramic material structure which has considerable structural strength.

A further aim of the present invention is to provide a ceramic material structure which is capable of easily withstanding repeated and rapid heating/cooling cycles, even with considerable thermal gradient.

A further aim of the present invention is to provide a ceramic material structure which is relatively simple to produce industrially, at relatively limited and economically competitive costs.

This aim and these objects, as well as other objects that will be apparent from the description below and from the accompanying drawings, are achieved according to the invention by a ceramic material structure and by a relative production process, respectively according to claims 1 and 10, proposed below.

The ceramic material structure according to the invention is comprises at least one layer of material comprising an effective quantity of Li—Al nesosilicates.

The ceramic material structure according to the invention is thus produced at least partly with a material comprising an effective quantity of Li—Al nesosilicates. Said material preferably comprises a mineral, which is commonly know as “pegmatite”.

Due to the use of Li—Al nesosilicates, the ceramic material structure according to the invention has substantially no or negative overall thermal expansion and has a considerable homogeneous lattice.

This allows them to easily withstand sudden changes in temperature, even if repeated, rapid and/or with high thermal gradient, without structural or lattice defects occurring.

As will be more apparent below, the ceramic material structure according to the invention can be easily produced at industrial level, even for mass productions.

Further characteristics and advantages of the ceramic material structure according to the invention can be better understood with reference to the description given below and to the accompanying figures, provided purely for explanatory and non-limiting purposes, wherein:

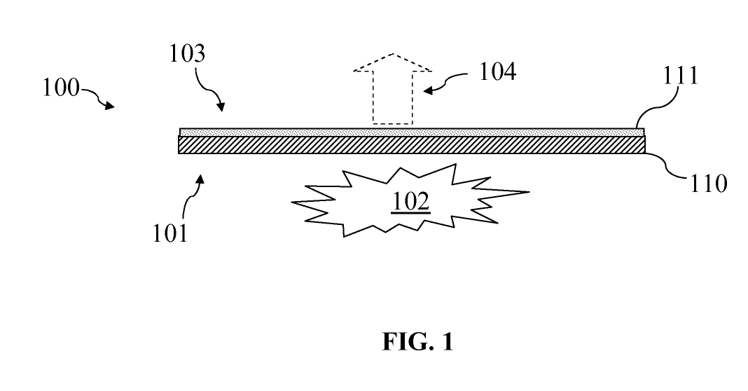

FIG. 1 schematically represents a sectional view of a ceramic material structure according to the invention; and

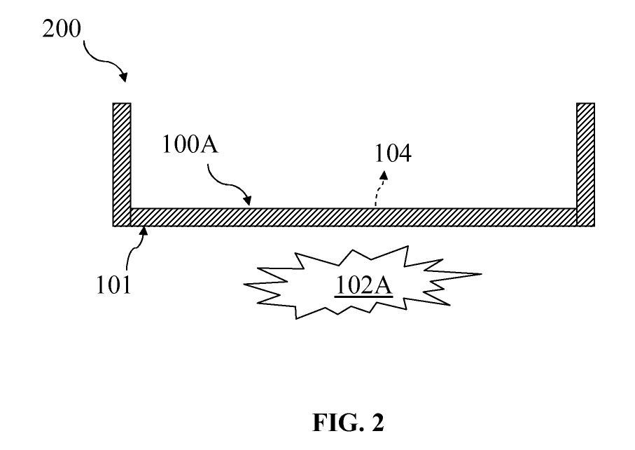

FIG. 2 schematically represents a sectional view of a cooking utensil, comprising a ceramic material structure according to the invention; and

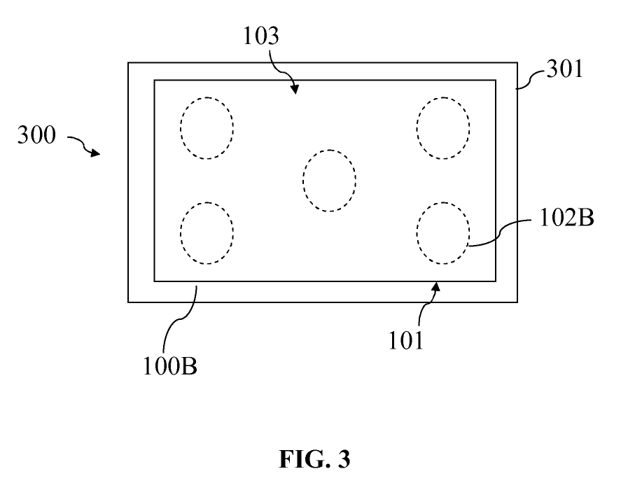

FIG. 3 schematically represents a top view of a cooking hob comprising a ceramic material structure according to the invention; and

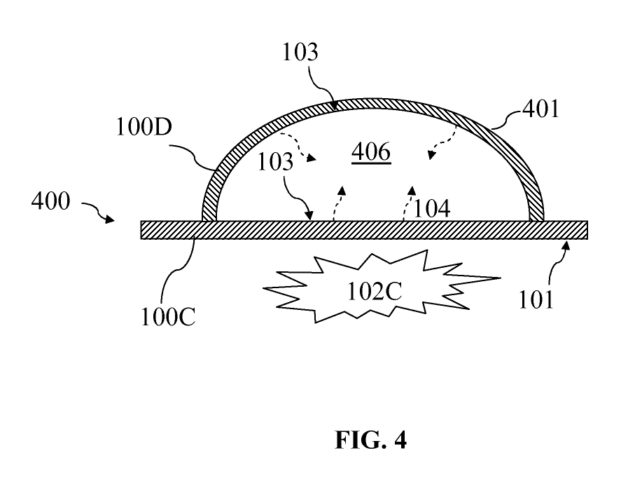

FIG. 4 schematically represents a sectional view of a cooking hob combined with a cooking cover, each comprising a ceramic material structure according to the invention; and

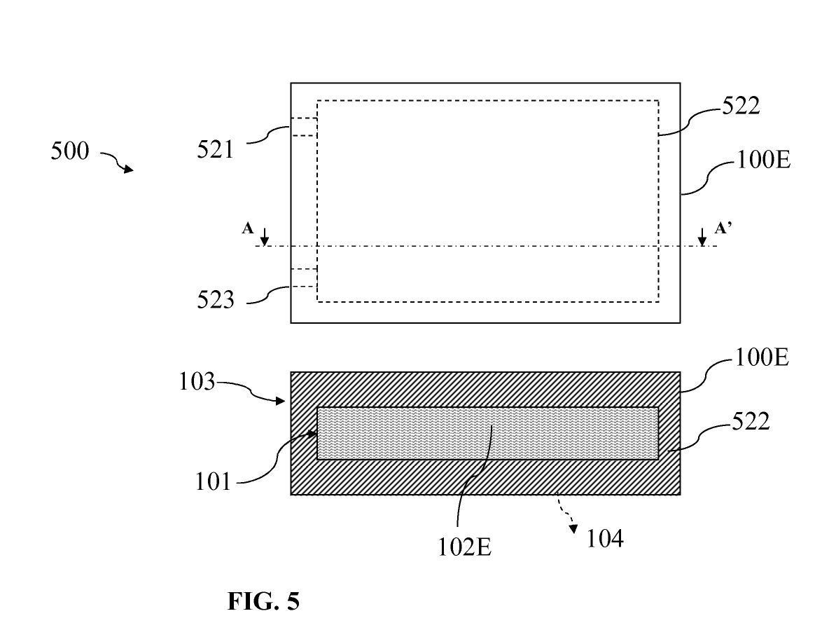

FIG. 5 schematically represents a front and a sectional view of a heating body for a heating system, which comprises a ceramic material structure according to the invention; and

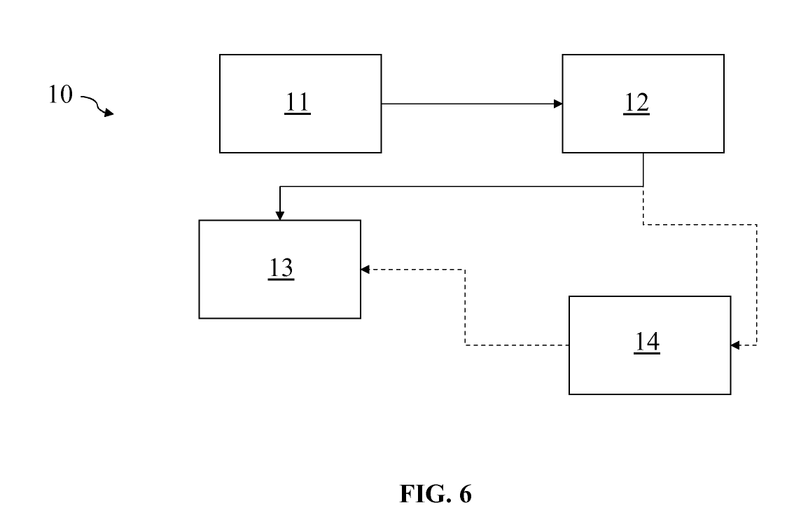

FIG. 6 represents a block diagram relative to a manufacturing process of the ceramic material structure according to the invention.

With reference to the aforesaid figures, the present invention relates to a ceramic material structure 100, which preferably comprises at least one surface 101 suitable to be exposed, directly or indirectly, to a source of heat 102. Said source of heat may be any, for example the combustion flames of a cooking hob or the heating water of a heating system.

The structure 100 is characterized in that it comprises at least one layer 110 comprising an effective quantity of Li—Al nesosilicates (FIG. 1).

The use of Li—Al nesosilicates makes it possible to obtain, for the structure 100, thermal expansion coefficients close to zero or negative, for a wide temperature range. Typically, thermal expansion coefficients constantly below 10 μm or negative are obtained for a temperature variation of 500° C.

Moreover, the intrinsic atomic structure of Li—Al nesosilicates, formed by rhombohedrons comprising Al atoms, allows a particularly strong and homogeneous crystalline lattice to be obtained for the structure 100.

From the above, it is apparent how, with respect to prior art, the use of Li—Al nesosilicates has the surprising effect of providing the structure 100 with high resistance to repeated and rapid heating/cooling cycles, even with very high thermal gradients, of over 500° C., preventing the onset of cracking phenomena.

The ceramic structure 100 may advantageously form a plate-like monolithic body, as shown in FIG. 1, but it may be produced with any shape, according to requirements.

The structure 100 preferably comprises a first heat exchange surface 101, suitable to be exposed, directly or indirectly, to a source of heat 102, and a second heat exchange surface 103, suitable to yield heat 104 into the surrounding environment.

At the surfaces 101 and/or 103, the structure 100 can comprise one or more layers of enamel 111 or of other materials (FIG. 1), which, in turn can comprise an effective quantity of Li—Al nesosilicates.

The structure 100 could also comprise several layers 110, each comprising an effective quantity of Li—Al nesosilicates. Each of said layers could be covered by layers of enamel or other materials.

The advantages described above in relation to the ceramic material structure 100, even if to more limited extent, are also found in the case in which the layer comprising an effective quantity of Li—Al nesosilicates simply forms a coating layer of a ceramic material substrate.

According to this alternative embodiment, not shown, the layer comprising an effective quantity of Li—Al nesosilicates may thus be represented simply by a coating layer, such as enamel, covering a generic ceramic material substrate.

The ceramic material structure 100 is particularly suitable for producing cooking utensils, such as baking pans, saucepans, oven-proof dishes, plates and the like.

As shown in FIG. 2, it can be used (reference 100A) as the base of a cooking utensil 200, such as a baking pan, and placed directly on a source of heat 102A, such as the naked flame of a gas hob or the cooking plate of a stove or oven. The side walls of the utensil 200 can be made of ceramic or another material. Alternatively, the ceramic material structure 100A can be moulded in such a manner as to form the entire structure of the utensil 200.

FIG. 3 shows the use of a ceramic material structure according to the invention (reference 100B) as a cooking hob 300. For this purpose, the structure 100B can be mounted on a frame 301, over one or more sources of heat 102B, which can, for example, comprise resistance or induction heating coils, halogen lamps or gas rings. Alternatively, the plate 100B can act as cooking hob for conventional gas rings or for stoves, ovens or fireplaces.

FIG. 4 shows the use of a ceramic material structure according to the invention (reference 100C) as cooking plate 400, usable for example in direct contact with a source of heat 102C, such as the plate of a stove or a naked flame. The cooking plate 400 can be used in association with a cover 401, also formed by a ceramic material structure 100D according to the invention. The cover 401 can be placed on the plate 400 in such a manner as to form, in cooperation therewith, a cooking cavity 406, in which cooking heat 104 is irradiated uniformly.

The ceramic material structure 100 is also suitable for producing heating bodies or heat exchanging elements for heating systems.

FIG. 5 shows the use of a ceramic material structure according to the invention (reference 100C) as a heating body 500, usable for example in a heating system.

The heating body 500 is preferably made of a monolithic hollow ceramic material structure 100E, according to the present invention. The heating body 500 preferably comprises an inlet 521 and an outlet 523, which allows the circulation of a heat fluid 102A, such as heating water, within one or more cavities 522 of the heating body 500. In this case, the heating fluid 102E represents the heat source to which the ceramic material structure 100E is exposed.

The shape and size of the heating body 500 may be any according to the needs. A plurality of heating bodies may be operatively connected to increase the heat radiation 104 transmitted from the heating fluid to the external environment.

The ceramic material structure 100 can advantageously be produced with the industrial process 10, described below.

The characteristic of this process lies in the fact that it comprises at least a first step 11 to prepare a ceramic mixture comprising an effective quantity of Li—Al nesosilicates.

The aforesaid ceramic mixture is advantageously obtained by mixing water, in a percentage of weight variable between 20-30%, and a group of substances comprising at least one mineral comprising Li—Al nesosilicates. This mineral can, for example, be a mineral known with the trade name “pegmatite”.

Preferably, in this group of substances to be mixed with water, the percentage in weight of said mineral varies between 50-60%. It has been found that a percentage in weight between 52-56%, and more preferably of 53%, is particularly effective to give the ceramic mixture thus obtained optimal properties of thermal stability.

The aforesaid group of substances to be mixed with water advantageously comprises clay and kaolin, according to percentages in weight preferably variable of around 20-25% for each of these substances. The use of clay and kaolin allows the mixture to be given the necessary plasticity to perform the subsequent processing steps.

Moreover, fluxing agents are advantageously used (such as nephalines, albites, orthoclase, borax, feldspars, limestone and dolomite) to decrease the refractoriness of the mixture and allow improved cementation of the components.

Preferably, tempers are also used to appropriately modulate the plasticity of the mixture. These tempers can comprise chamotte or silica, as in common ceramics or, preferably, mullite, in order to further enhance the described stabilizing action (from a thermal viewpoint) of the Li—Al nesosilicates.

Sodium silicate or, even more preferably, polyacrylates can also be used in the ceramic mixture, preferably in a percentage in weight of around 1%.

The aforesaid ceramic mixture is preferably worked until reaching the appropriate viscosity, i.e. of around 240 mm²/s at 40° C.

After preparing the ceramic mixture, the process 10 preferably comprises some subsequent steps 12-14 for the preparation of ceramic components having the desired shape/size.

Therefore, the process 10 advantageously comprises a second step 12 of moulding the ceramic material structure 100, using the ceramic mixture prepared in the first step 11.

In practice, in this step 12, the aforesaid ceramic mixture is advantageously poured into a plaster mould, suitable to give the desired shape to the structure 100.

The ceramic mixture is kept inside the mould for a few hours until obtaining inspissation and solidification thereof.

After having been removed from the mould, the solidified ceramic mixture is removed from the mould and subjected to drying for a few days, and subsequently to blowing/lapping.

The process 10 then comprises a third step 13 of heat treating the ceramic structure thus obtained. For this purpose, one or more drying and/or baking cycles can be used, at temperatures varying between 1100 and 1300° C.

Preferably, before the heat treatment step 13, the process 10 can also comprise a step 14 of painting the structure 100 with enamel.

The enamel preparations, usable in step 14, preferably comprise one or more of the substances selected from: water, clay, kaolin, talc, quartz, calcium silicate, fluxing agents (such as nephalines, albites, orthoclase, borax, feldspars, limestone and dolomite), oxidizing agents (such as zinc, zirconium, barium, calcium, tin, sodium, potassium, magnesium) and/or bonding agents (such as cellulose).

The aforesaid enamel preparations can also comprise an effective quantity of Li—Al nesosilicates.

Using the process 10 according to the present invention, a ceramic material structure 100, of monolithic type, was produced according to the embodiment shown in FIG. 1.

A percentage in weight of water of 24% mixed with a group of solid substances was advantageously used in the first preparation step 11 of the ceramic mixture. This group includes clay (percentage in weight of 22%), kaolin (22%), polyacrylate (1%), pegmatite (53%), chamotte and, alternatively, mullite.

In the subsequent moulding step, the mixture was kept in a plaster mould for about 4 h, in order to give the structure 100 the desired shape.

The structure 100, thus obtained, was subsequently subjected to drying for about 2 days (average ambient temperature of 24° C.).

After the moulding step 12, the outside of the structure 100 was painted with an enamel containing the following substances: clay, quartz, sodium feldspar, zinc oxide, zirconium silicate, borax, calcium silicate and kaolin.

After painting, the structure 100 was subjected to baking, at a temperature of 1240° C. for around 12 hours.

Laboratory tests performed on the ceramic material structure according to the invention thus obtained showed that it is capable of withstanding, without cracking phenomena, hundreds of heating/cooling cycles, lasting a few seconds, with thermal gradients of over 500° C.

In practice, it was found that the ceramic material structure 100, and the relative industrial production process according to the present invention allow prior art problems to be solved and have numerous advantages with respect thereto.

In particular, it was found that the use of Li—Al nesosilicates allows a drastic reduction in the possibility of fractures and/or cracks during repeated heating/cooling cycles.

The ceramic material structure according to the invention therefore has considerable qualities of resistance to sudden temperature changes, even of considerable magnitude, for example of over 500° C.

Moreover, the use of ceramic material ensures optimal performances in terms of uniform heat emission, noteworthy scratch-resistance and non-stick properties and noteworthy energy yield.

The ceramic material structure according to the invention can be easily worked and/or decorated during the aforesaid moulding or painting steps, or subsequently. In this manner, it can assume particularly pleasing shapes and colours for the user. For example, in its use as cooking hob, it can be coloured or produced with customized shapes and thicknesses, so as to become a true furnishing accessory, capable of enhancing the appearance of the room in which it is located.

As has been seen, the ceramic material structure according to the invention can be produced easily at industrial level, also for mass productions. For this purpose, tools and machinery commonly available on the market can be used.

1. A ceramic material structure wherein it comprises at least one layer of material comprising an effective quantity of Li—Al nesosilicates.

2. The ceramic material structure according to claim 1, wherein it further comprises one or more layers of enamel, at least one of said layers of enamel comprising an effective quantity of Li—Al nesosilicates.

3. The ceramic material structure according to claim 1, wherein it comprises at least one layer of material comprising an effective quantity of pegmatite.

4. The ceramic material structure according to claim 1, wherein it comprises a first heat exchange surface, suitable to be exposed directly or indirectly to a source of heat and a second heat exchange surface suitable to yield heat into the surrounding environment.

5. The ceramic material structure according to claim 1, wherein said layer of material comprising an effective quantity of Li—Al nesosilicates forms a base layer and/or an inner layer and/or a substrate and/or a coating layer of: aid ceramic material structure.

6. The ceramic material structure according to claim 1, wherein it forms a plate-like monolithic body.

7. A cooking utensil wherein it comprises a ceramic material structure according to claim 1.

8. A cooking hob wherein it comprises a ceramic material structure, according to claim 1.

9. A cooking plate wherein it comprises a ceramic material structure, according to claim 1.

10. A cooking cover wherein it comprises a ceramic material structure, according to claim 1.

11. A heating body for a heating system wherein it comprises a ceramic material structure, according to claim 1.

12. A process for producing a ceramic material structure wherein it comprises at least a first step of preparing a ceramic mixture comprising an effective quantity of mineral containing Li—Al nesosilicates.

13. The process according to claim 12, wherein it comprises a second step of moulding at least one layer of said ceramic structure, using the ceramic mixture prepared in said first step.

14. The process according to claim 13, wherein it comprises a third step of heat treating the layer moulded in said second step.

15. The process according to claim 12, wherein said ceramic mixture is produced by mixing water and a group of substances comprising at least one mineral comprising Li—Al nesosilicates and one or more of the substances selected from: clay, kaolin, sodium silicates, polyacrylates, feldspars, fluxing agents and/or tempers.

16. The process according to claim 15, wherein said group of substances comprises a percentage in weight of between about 40% and 60% of said mineral containing Li—Al nesosilicates.

17. The process according to claim 16, wherein said group of substances comprises a percentage in weight of between about 52% and 56% of said mineral containing Li—Al nesosilicates.

18. The process according to claim 17, wherein said group of substances comprises a percentage in weight of 53% of said mineral containing Li—Al nesosilicates.

19. The process according to claim 15, wherein said mineral containing Li—Al nesosilicates comprises pegmatite.

20. The ceramic material structure according to claim 2, wherein it comprises at least one layer of material comprising an effective quantity of pegmatite.
